(19) United States
(12) Patent Application Publication
(10) Pub. No.: US 2004/0114726 A1
(43) Pub. Date: Jun. 17, 2004

(54) Method for Calibrating bone mineral density index variation and recording medium for storing program for executing the same

(76) Inventors: Sooyeul Lee, Yuseong-Gu (KR); Seunghwan Kim, Yuseong-Gu (KR); Ji-Wook Jeong, Yuseong-Gu (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/672,726

(22) Filed: Sep. 25, 2003

(30) Foreign Application Priority Data
Dec. 13, 2002 (KR) 2002-79637

(51) Int. Cl. G01N 23/06; G01B 15/02; G01D 18/00

(52) U.S. Cl. 378/207

(57) ABSTRACT

Disclosed are a method of calibrating the bone mineral density index if the bone mineral density is to be measured using the X-ray image and a recording medium readable by a computer, on which a program for executing the method is recorded. The method comprises acquiring a phantom X-ray image having a region of two or more different thickness taken along with an object and calibrating the bone mineral density index of the object using the phantom. According to the present invention, it is possible to calibrate variation in the bone mineral density index caused by variation in X-ray radiographic condition.

### BACKGROUND OF THE INVENTION

1. Field of the Invention

The present invention relates to a method for calibrating bone mineral density index variation caused by variation in X-ray radiographic condition, in measuring the bone mineral density using the X-ray image, and a recording medium readable by a computer, on which a program for executing the method is stored.

2. Background of the Related Art

Osteoporosis is a wide-spread medical condition that affects the middle-aged and older populations. Especially, the condition is prevalent in postmenopausal women. Osteoporosis is characterized by an abnormal loss in bone mineral content, which leads to a tendency toward non-traumatic bone fractures and to structural deformations of bones. However, effective therapy for osteoporosis has not been developed yet. Accordingly, it is important that a method for easily and inexpensively diagnosing the osteoporosis should be developed for the prevention of deterioration of osteoporosis and early stage treatment of osteoporosis.

Bone mineral density is one of important factors for diagnosing osteoporosis. Various bone mineral density measurement methods have been developed.

Quantitative computed tomography (QCT) provides a three-dimensional bone density image and thus provides separate estimations of cortical and trabecular bone densities. Based on the three-dimensional bone density image, QCT method can provide a structural strength of a bone to some extent. However, there are some limitations to use the QCT as a routine screening tool for osteoporosis because the price of the QCT equipment is very high and the radiation dose of a QCT scan is generally several hundred times larger than that of a plain x-ray imaing.

The most widely used method for measuring bone mineral density and for follow-up study of osteoporosis patients is a dual-energy x-ray absorptiometry (DEXA). The precision error of the DEXA in determining bone mineral density is reported to be about few percents. Furthermore, the radiation dose of a DEXA scan is very small compared with a QCT scan.

Ultrasound (US) is also used for measuring bone mineral density. However, US is not so accurate in determining bone mineral density compared with other equipments. Nevertheless, the validity of US for osteoporosis study does not diminish because some studies have reported that US is somewhat relevant to the mechanical strength of bone.

In spite of the various methods prescribed above, such as QCT, DEXA, and US, other methods for measuring bone mineral density and diagnosing osteoporosis by using a plain x-ray image are developed steadily in the practical point of view. The main reason is that most hospitals are generally equipped with an x-ray radiographic system, so there is no need for an extra cost to purchase a new bone mineral density measuring system. Moreover, the high quality of the x-ray image enables trabecular pattern analysis. Recently, trabecular pattern is believed to contain useful information about the fracture risk due to osteoporosis. In this sense, many studies have studied trabecular patterns to extract useful information related to the fracture risk.

So far, several methods for measuring the bone mineral density using the x-ray image have been presented. These methods, however, are not widely used in the clinic. This is because various instability (instability in the X-ray radiographic condition and film development process) that is accompanied during the time when the X-ray image is acquired may cause a significant error in the bone mineral density. In particular, it is difficult to eliminate instability of the X-ray radiographic condition with user's carefulness unlike instability in the film development process.

### SUMMARY OF THE INVENTION

Accordingly, the present invention is contrived to substantially obviate one or more problems due to limitations and disadvantages of the related art.

An object of the present invention is to provide a method of using a phantom in order to compensate for variation in the bone mineral density index caused by variation in the X-ray radiographic condition when it is desired to measure the bone mineral density using the X-ray image, and a recording medium readable by a computer, on which a program for executing the method is recorded.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of calibrating a bone mineral density index according to the present invention is characterized in that it comprises the steps of (a) obtaining an image in which an object and a phantom having regions of at least two different thickness are radiographed at the same time; (b) calculating the bone mineral density index of the object and the average gray level in the each region of the phantom from the radiographed image; (c) repeating the steps (a) and (b) N times to extract a correlation equation between the bone mineral density index and the average gray level in each region of the phantom; and (d) calibrating the bone mineral density index variation caused by the variation of x-ray radiographic condition.

Meanwhile, the phantom includes a region having different thickness of M (at least 2) in number and the correlation equation is expressed into the following equation (6) using a continuous function satisfying H(G,0,0)=0.

[symbol] =H(G, A−A₀, B−B₀, C−C₀, . . . ) (wherein [symbol] is the amount of variation in the bone mineral density index of the object, G is the bone mineral density index of the object, A, B, C . . . are the average gray levels in the regions having different thickness of M in number in the phantom region, A₀, B₀ and C₀ are the average values obtained by performing X-ray radiography N times and averaging A, B, C . . . obtained from each of the images in the regions having different thickness of M in number in the phantom region)

“Object” indicates a portion of the bone from which the bone mineral density is to be measured, which includes all the portions of the bones in a human being or an animal.

It is preferred that “phantom” is made of from a material similar to a skin tissue. For example, the phantom may be made using acrylic polymer, styrene polymer, polyethylene, polypropylene, polyester polymer, polyamide polymer or polyurethane polymer.

Meanwhile, according to another embodiment of the present invention, a recording medium readable by a computer, on which a program for executing the method of calibrating the bone mineral density index is stored, is provided.

In another aspect of the present invention, it is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a hardware system for executing a method of calibrating the variation in the bone mineral density index according to a preferred embodiment of the present invention,

FIG. 2 is a flowchart illustrating a method of calibrating the variation in the bone mineral density index using an X-ray image including an acrylic phantom according to the present invention,

FIG. 3 shows one exemplary structure of the acrylic phantom,

FIG. 4 shows one example of the X-ray image including the acrylic phantom,

FIG. 5 shows one exemplary structure of an aluminum phantom,

FIG. 6 shows one example of the X-ray image including the acrylic phantom and the aluminum phantom,

FIG. 7 is a flowchart illustrating a method of measuring a radius bone mineral density index according to a preferred embodiment of the present invention,

FIG. 8 is a graph showing the correlation between the thickness and the average gray level of the aluminum phantom,

FIG. 9 illustrates one exemplary wrist X-ray image calibrated using the aluminum phantom and a rectangular region selected in order to measure the radius bone mineral density index, and

FIG. 10 is a graph showing a profile of the gray level depending on the pixel position at a crossing line l in FIG. 9

### DETAILED DESCRIPTION OF THE PREFERRED EMBODIMENT

A method of calibrating the variation in a bone mineral density index will be now described in detail with reference to the accompanying drawings. In the following embodiment, a case where an acrylic phantom having regions of two different thickness is used will be described. However, it is evident to those skilled in the art that the present invention is not limited thereto.

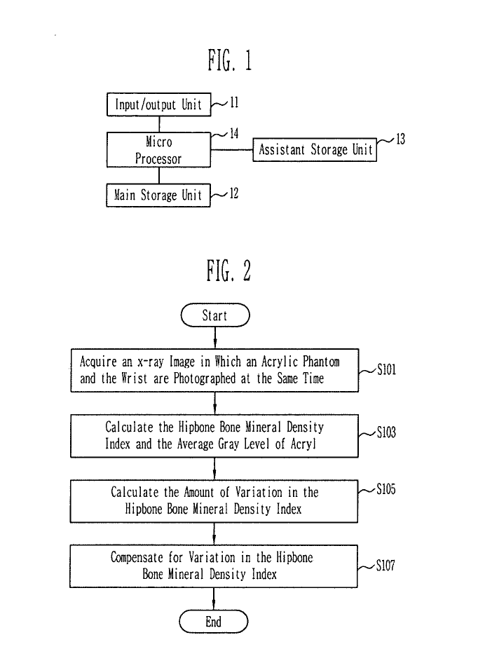

FIG. 1 is a block diagram of a hardware system for executing a method of calibrating the variation in the bone mineral density index according to a preferred embodiment of the present invention.

The hardware system comprises an input/output unit 11 for inputting/outputting data from/to a user, main/assistant storage units 12 and 13 for storing various data required for the course of measuring a bone mineral density index using a X-ray image, and a microprocessor 14 for controlling the main/auxiliary storage units 12 and 13 and the input/output unit 11, measuring the bone mineral density index using the X-ray image and executing general operations for performing the method of calibrating the bone mineral density index using the acrylic phantom.

The input/output unit 11 may be a monitor, a printer, an X-ray film scanner digitalizing X-ray films, and the like. Furthermore, a digital image sensor may be included in the input/output unit 11 where the digital image sensor [charge-coupled device (CCD) or complementary metal oxide silicon (CMOS) sensor] is used instead of the X-ray film.

The main/auxiliary storage units 12 and 13 may be CD ROM, RAM, ROM, floppy disks, hard disks, optomagnetic disks, etc., which can store the program for executing the method of calibrating the variation in the bone mineral density index in a format readable by the computer.

Through the mentioned system, the program for executing the method of calibrating the variation in the bone mineral density index is executed. If the program is executed by inputting the X-ray image into the input/output unit 11 in a state where the program including this process is built in the microprocessor 14, the program measures the bone mineral density index and performs the method of calibrating the variation in the bone mineral density index.

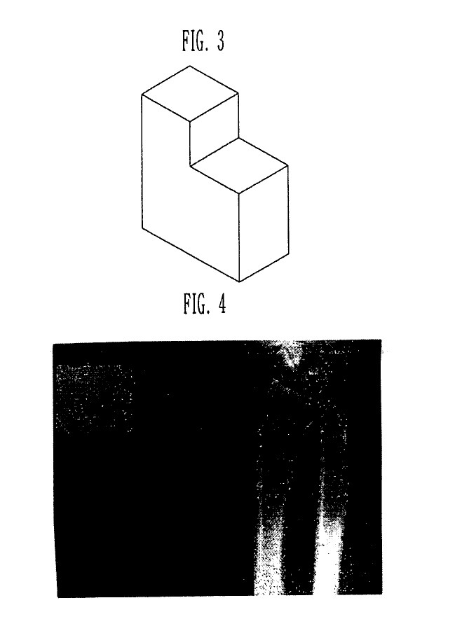

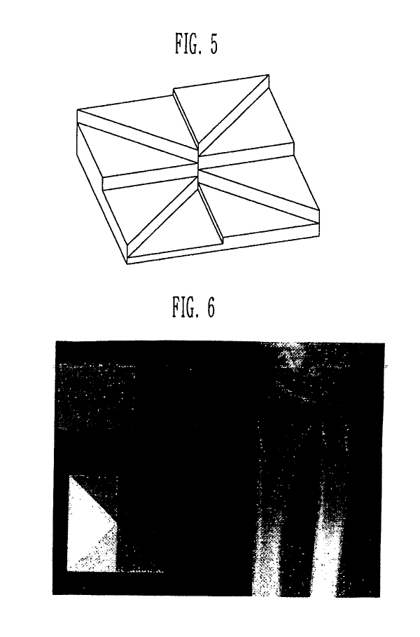

The method of calibrating the variation in the bone mineral density index using the X-ray image including an acrylic phantom according to one embodiment of the present invention will be now described with reference to FIG. 2˜FIG. 4.

An X-ray image in which the acrylic phantom shown in FIG. 3 and an object (radius in the present embodiment) are radiographed together is first obtained S101. FIG. 3 shows the acrylic phantom according to the present embodiment. In the present embodiment, two-step acrylic phantom is shown as one example in FIG. 3. The base side of acryl is 60 mm×30 mm and the heights of acryl are each 60 mm and 40 mm. FIG. 4 shows one example of the X-ray image including the acrylic phantom.

When the X-ray image is obtained, the tube voltage (kVp) of the X-ray generator is constant. For example, the tube voltage of the X-ray generator keeps 50 kVp (hereinafter called ‘standard tube voltage’). The X-ray image may be obtained by digitalizing the X-ray film obtained through simple X-ray radiography using the X-ray film scanner. In case of using the digital image sensor, the X-ray image is directly obtained without using the film scanner. When the X-ray image is obtained, the spatial resolution may be 200PPI (pixels per inch) and each of the pixels may have a 256 gray level of 8-bit depth.

Thereafter, in the wrist x-ray image, the radius bone mineral density index (G) and the average gray levels of acryl are calculated S103. The average gray levels of acryl are values each measured at the regions of 40 mm and 60 mm in thickness. In this case, the radius bone mineral density index (G) of the wrist X-ray image may be measured using the common method. Furthermore, it is possible to perform a calibration method unlike the calibration method of the present invention for the wrist X-ray image and then to implement the present invention. For example, Korean Patent Application No. 2001-45123 applied by the present applicant discloses a method of radiographing the wrist and the aluminum phantom together to calibrate the wrist X-ray image in detail. It is possible to previously additionally implement calibration using the aluminum phantom before the calibration method using the acrylic phantom of the present invention. This will be explained in detail later.

Next, the amount of variation in the radius bone mineral density index is calculated S105. This will be now described in detail. It is assumed that the average gray level is A after calibration of 60 mm acryl and the average gray level is B after calibration of 40 mm acryl. Further, it is assumed that Go, A₀ and B₀ are G, A and B at a correct standard tube voltage (50 kVp), respectively. If the X-ray generating condition is correct, G₀, A₀ and B₀ are each equivalent to Go, AO and Bo. However, the X-ray generating condition in the X-ray radiographic system that is used in an actual clinic may vary. So, G, A and B may not be equivalent to G₀, A₀ and B₀ respectively. Fortunately, it can be seen that an approximate functional relationship exists between the amount of variation in the bone mineral density index ( [symbol] =G−G₀), G, A−A₀ and B−B₀. Therefore, [symbol] may be expressed into the following equation (1).

[symbol]

=H(G, A−A₀, B−B₀) (1)

H is a continuous function satisfying H (G, 0, 0)=0. Although a case where the acrylic phantom includes the regions of two different thicknesses has been described in the present embodiment, the acrylic phantom may include regions of M in number. In this case, Equation (1) may be expressed into the following equation (2).

[symbol]

=H(G, A−A₀, B−B₀, C−C₀, . . . ) (2)

Meanwhile, according to the X-ray experiment, in case of the acryl phantom having the regions of two different thickness in Equation (2), [symbol] was reduced if B−B₀ is increased, and [symbol] was increased if A−A₀ is increased. Also, it was found that [symbol] is almost proportional to G. If an empirical equation is desired to establish through these facts, the following equation (3) can be expressed.

[symbol]

=c₁G(c₂(A−A₀)−(B−B₀)) (3)

In Equation (3), c₁ and c₂ are constants. Equation (3) indicates the amount of variation in the radius bone mineral density index caused by variation in the X-ray radiographic condition.

Thereafter, variation in the radius bone mineral density index is compensated for by subtracting variation in the radius bone mineral density index ( [symbol] ) from the radius bone mineral density index (G) S107. As the amount of variation in the radius bone mineral density index is expressed into Equation (3) using the gray level of acryl, the radius bone mineral density index at the standard tube voltage can be expressed into the following equation (4).

G₀=G−c₁G(c₂(A−A₀)−(B−B₀)) (4)

Equation (4) is the results that variation in the radius bone mineral density index caused by variation in the X-ray radiographic condition is compensated for using the 40 mm and 60 mm acryl. Meanwhile, in order to use Equation (4) in an actual clinic, it is required to decide the constants c₁, c₂, A₀ and B₀. Because the stability of the standard tube voltage is not complete, averages of multiple measurement results of A and B under the nominal standard tube voltage condition are used. For example, after X-ray radiography is implemented more than 10 times under the standard tube voltage (50 kVp), A and B obtained from respective images are averaged and are then set to A₀ and B₀. Meanwhile, the constants c₁ and c₂ are determined from X-ray radiography for a plurality of subjects. X-ray radiography is implemented 10 times for the respective subjects and the standard deviation ( [symbol] ₛ) of [symbol] is calculated within the same subject while varying c₁ and c₂. Next, the constants c₁ and c₂ are set to values where the sum of [symbol] ₛ over the entire subjects is minimized. An optimum cl set in the wrist X-ray radiographic experiment that is implemented for subjects of 10 persons, is about 0.005 and c₂ is about 0.72. An optimum c₂ may have a value of 0.6˜0.8 depending on the X-ray equipment.

(Measurement of the radius bone mineral density index (G) in the wrist X-ray image)

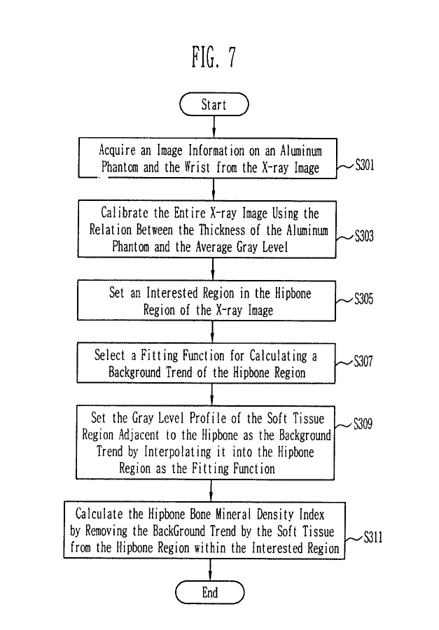

A method of implementing the method of radiographing the wrist and the aluminum phantom together to calibrate the wrist X-ray image, disclosed in Korean Patent Application No. 2001-45123, and the method of calibrating the variation in the bone mineral density index using the acrylic phantom according to the present invention together will be now described. In this method, the aluminum phantom and the acrylic phantom along with the wrist are radiographed (see FIG. 6). The aluminum phantom is used to calibrate the X-ray image and serves to calibrate variation in the image characteristic due to characteristics of the X-ray generator, the type of the screen and film, a film development condition, and a X-ray film digitizer characteristic (in case of the digital image sensor, CCD or CMOS sensor), and the like. FIG. 5 shows one example of this type of the aluminum phantom structure. FIG. 7 is a flowchart illustrating the process of measuring the radius bone mineral density index (G) using the x-ray image where the wrist and the aluminum phantom are radiographed together.

The gray level information on the aluminum phantom and wrist is obtained from the image S301.

The aluminum phantom consisting of a plurality of steps, as shown in FIG. 5, are used in order to quantify the X-ray absorption in respective pixels. The aluminum phantom shown in FIG. 5 is a regular square having a base side of 40 mm×40 mm and is made by machining an aluminum plate of 12 mm in thickness to have a radial stair of 8 steps. The heights of the steps of the aluminum phantom are 1.5, 3.0, 4.5, 6.0, 7.5, 9.0, 10.5 and 12.0 mm, respectively, from the lowest one.

Measurement of the bone mineral density using the X-ray usually uses the X-ray absorption property by the bone. The entire X-ray image is thus calibrated using the relation between the each step's thickness and the average gray level S303. By doing so, each pixel's gray level of the calibrated x-ray image represents a quantitative value proportional to the x-ray absorption length of the aluminum for a given x-ray exposure condition.

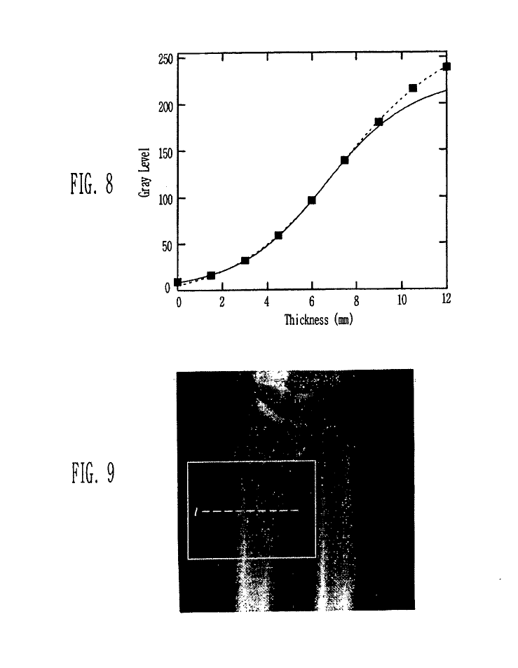

In order to calibrate the entire X-ray image using the aluminum phantom, it is required that a gray level value at a given thickness be first calculated. In order to calculate a gray level at a given aluminum thickness, two-dimensional data indicating correlation between the thickness and the average gray level of the aluminum phantom in FIG. 8 may be fitted using an appropriate function. From FIG. 8, it can be seen that the gradient of the gray level is gradually increased as the thickness of aluminum is increased but the gradient of the gray level is reduced later. A representative function representing this characteristic is a tangent hyperbolic function. Accordingly, it is preferred that a fitting function of f(t)=a +b*tanh(c*t+d) type is used, wherein f(t) indicates the gray level, t indicates a thickness of aluminum (mm units), and a, b, c and d indicate fitting parameters. At this time, the “tanh” function is completely symmetric around a point being t=−d/c. As shown in FIG. 8, however, a gray level profile of the aluminum phantom is not completely symmetric. Therefore, as a significant fitting error may be caused if data is fitted using single tanh function, data is fitted with divided into two fitting regions. In each fitting region, the fitting function needs four or more data since there are four fitting parameters.

The first fitting region consists of 6 data from 0 mm step to 7.5 mm step in the height and the second region consists of 6 data from 4.5 mm step to 12.0 step in the height. In the above, the reason why the two regions are overlapped is to make a transition region for smoothly connecting the fitting results in the two regions. Thereafter, data are fitted in the respective regions using the fitting function. The fitting may use a Levenberg-Marquardt fitting method.

The fitting result in the first region is indicated by f₁(t), the fitting result in the second region is indicated by f₂(t) and the results thereof are indicated by a solid line and a dotted line, respectively, in FIG. 8. One final fitting function F(t) is produced using the two fitting functions by means of the following method. It is assumed that F(t)=f₁(t) in a section t<=4.5, F(t)=f₂(t) in a section t>=7.5 and F(t)=x*f₁(t)+(1−x)f₂(t) in a section 4.5<t<7.5. At this time, x=(7.5−t)/3. As the function F(t) is a monotonously increasing function, an inverse function F⁻¹(g) is uniquely determined. In the above, g is the gray level. The gray level g of each of the pixels of the X-ray image is calibrated using the final fitting function F(t) as follows. If g>=F(12), a calibration value is 255. If g<=F(0), a calibration value is 0. In other case, the calibration value is an integer part of 256*F⁻¹(g)/12.

FIG. 9 shows one example of an image calibrated by the mentioned method. Each of the pixels in FIG. 9 consists of the gray level directly related to the X-ray absorption by the human body. X-ray absorption by the human body is decided by the density, thickness, etc. of the bone and the soft tissue. The X-ray bone image includes the X-ray absorption effect by the overlapped soft tissue at the same time. Accordingly, in order to measure the density of the bone only using the gray level of the X-ray bone image, it is required that the X-ray absorption effect by the soft tissue included in the X-ray bone image be eliminated.

Thereafter, in order to eliminate the X-ray absorption effect by the soft tissue included in the X-ray bone image, a region of interest (ROI) is set in the radius region S305. For example, the size of the ROI shown in FIG. 9 may be 350×300 pixels. The soft tissue region is included in right and left sides of the radius region.

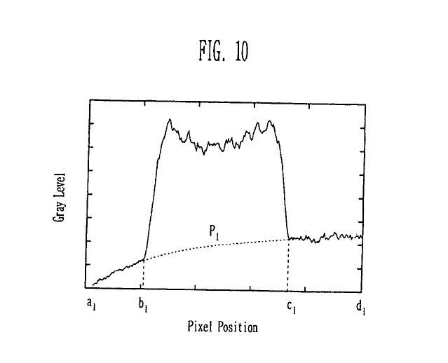

Next, in order to calculate a background trend by the soft tissue in the radius region, a fitting function is selected S307. A gray level profile at one crossing line l within the ROI in FIG. 9 is shown in FIG. 10 by a solid line. In FIG. 10, the horizontal is a coordinate of the pixel and the vertical is the gray level. In FIG. 10, sections a₁˜b₁, b₁˜c₁ and c₁˜d₁ indicate the soft tissue section, the radius section, and the soft tissue between the radius and the ulna, respectively. In the radius section in FIG. 10, it is impossible to exactly calculate the background trend by the soft tissue. Accordingly, an approximate method for calculating the background trend is used. The method includes interpolating the gray level profiles of soft tissue sections (a₁˜b₁ and c₁˜d₁) into the radius section b₁˜c₁ to set it to the background trend. For interpolation, a differentiable fitting function is first selected. In general, a polynomial is adequate as the fitting function. In this invention, however, a 4^{th} order polynomial [P(x)=C₀+C₁x+C₂x₂+C₃x₃+C₄x₄] is used as the fitting function. In the above, C₀, C₁, C₂, C₃ and C₄ are fitting parameters.

Thereafter, a background trend is calculated by interpolating the gray level profiles of the soft tissue regions into the radius region using the fitting function S309. This process will be below described in more detail. The gray level profile in the soft tissue sections aₗ˜bₗ and cₗ˜dₗ adjacent to the radius section is interpolated into the radius region. Meanwhile, interpolation is performed in the Levenberg-Marquardt fitting method. The interpolation result of the radius region is the background trend by the soft tissue. Pₗ in FIG. 10 is the background trend that is set by interpolation using the fitting function. The background trend by the soft tissue is calculated while the crossing line l is moved to all the rows within the ROI.

If the background trend by the soft tissue is set as above, the background trend is eliminated from the gray level of the radius region and the radius bone mineral density index (G) is then calculated S311. This process will be now described in more detail. This process includes a process of eliminating the set background trend from the gray level of the bone region and a process of setting the average of the gray level in which the background trend is eliminated from the radius region as the radius bone mineral density index. Therefore, the radius bone mineral density index can be expressed into the following equation (5).

$$G = \frac{1}{A} {\sum }_{l} {\sum }_{n = {b}_{l}}^{{c}_{l}} {G}_{l n} , A = {\sum }_{l} \vert {b}_{l} - {c}_{l} \vert \qquad ( 5 )$$

In Equation (5), Gₗₙ is the gray level profile in which the background trend owing to the soft tissue is eliminated, n is an index of the pixel, and A is an area of the bone region. At this time, the bone mineral density index (G) is a measure of the bone mineral density.

The bone mineral density index (G) measured as such may be used as the bone mineral density index in the step S103 of FIG. 2. The method of calibrating the variation in the bone mineral density index of the present invention is implemented by performing the mentioned steps S103˜S107.

As described above, although a specific embodiment of the present invention has been described above, numerical values or images used in the present invention may be modified for improved performance of the method according to the present invention. In the existing methods to measure bone mineral density using x-ray images, variation in the bone mineral density caused by variation in the X-ray radiographic condition, etc. is not compensated for. For this reason, measurement error due to instability of the X-ray radiographic apparatus occurred. In the present invention, however, 40 mm and 60 mm acryl is used in order to compensate for variation in the bone mineral density caused by variation in the X-ray radiographic condition.

As described above, the present invention has an advantageous effect that it allows more exact measurement of the bone mineral density by calibrating the variation in the bone mineral density index caused by various instability (instability in the X-ray radiographic condition and film development process) that is accompanied during the time when the X-ray image is acquired where the bone mineral density is to be measured using the X-ray image.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed are:

1. A method of calibrating a bone mineral density index, comprising the steps of:
(a) obtaining an image in which an object and a phantom having regions of at least two different thickness are radiographed at the same time;
(b) calculating the bone mineral density index of the object and the average gray level in the each region of the phantom from the radiographed image;
(c) repeating the steps (a) and (b) N times to extract a correlation equation between the bone mineral density index and the average gray level in each region of the phantom; and
(d) calibrating the bone mineral density index variation caused by the variation of x-ray radiographic condition.

2. The method as claimed in claim 1, wherein the phantom includes a region having different thickness of M (at least 2) in number and the correlation equation is expressed into the following equation (6) using a continuous function satisfying H(G,0,0)=0. [symbol]
=H(G, A−A₀, B−B₀, C−C₀, . . . ) (6)
(wherein [symbol] is the amount of variation in the bone mineral density index of the object, G is the bone mineral density index of the object, A, B, C . . . are the average gray levels in the regions having different thickness of M in number in the phantom region, A₀, B₀ and C₀ are the average values obtained by performing X-ray radiography N times and averaging A, B, C . . . obtained from each of the images in the regions having different thickness of M in number in the phantom region)

3. The method as claimed in claim 2, wherein M is 2 and the continuous function is a function expressed into the following equation (7). [symbol]
=c₁G(c₂(A−A₀)−(B−B₀)) (wherein c₁ and c₂ are constants) (

4. The method as claimed in claim 1, wherein the phantom is made from acrylic polymer, styrene polymer, polyethylene, polypropylene, polyester polymer, polyamide polymer or polyurethane polymer.

5. The method as claimed in claim 1, wherein the bone mineral density index in the step (b) is calculated by the steps of:
setting a background trend by interpolating the gray level profiles of nearby soft tissue regions into the object region;
removing the background trend from the gray level in the object region; and
setting the average of the gray level in which the background trend is eliminated from the object region as the bone mineral density index.

6. The method as claimed in claim 5, wherein the bone mineral density index is expressed into the following equation.
$$G = \frac{1}{A} {\sum }_{l} {\sum }_{n = {b}_{l}}^{{c}_{l}} {G}_{l n} , A = {\sum }_{l} \vert {b}_{l} - {c}_{l} \vert$$
(wherein Gₗₙ is the gray level profile from which the background trend is eliminated, n is an index of the pixel, l is a row index in the bone region, bₗ and cₗ denote the start pixel and the end pixel of the bone region in the row l, respectively, A is an area of the bone region, and G is the bone mineral density index).

7. A recording medium readable by a computer, on which a program for executing the method of calibrating the variation in the bone mineral density index written in claim 1 is stored.

8. A recording medium readable by a computer, on which a program for executing the method of calibrating the variation in the bone mineral density index written in claim 2 is stored.

9. A recording medium readable by a computer, on which a program for executing the method of calibrating the variation in the bone mineral density index written in claim 3 is stored.

10. A recording medium readable by a computer, on which a program for executing the method of calibrating the variation in the bone mineral density index written in claim 4 is stored.

11. A recording medium readable by a computer, on which a program for executing the method of calibrating the variation in the bone mineral density index written in claim 5 is stored.

12. A recording medium readable by a computer, on which a program for executing the method of calibrating the variation in the bone mineral density index written in claim 6 is stored.
